(19) United States
(12) Patent Application Publication
(10) Pub. No.: US 2009/0248542 A1
(43) Pub. Date: Oct. 1, 2009

(54) SYSTEMS AND METHODS FOR FACILITATING CREATIVE CONTENT DISCOVERY, SALE AND INVESTMENT

(76) Inventors: Robert C. Houvener, Hollis, NH (US); Lawrence G. Clawson, JR., Tyngsborough, MA (US)

Correspondence Address: CHOATE, HALL & STEWART LLP, TWO INTERNATIONAL PLACE, BOSTON, MA, 02110, US

(21) Appl. No.: 12/054,913

(22) Filed: Mar. 25, 2008

(51) Int. Cl. G06Q 30/00

(52) U.S. Cl. 705/27

(57) ABSTRACT

In one aspect, the present invention relates to a web site which addresses the above difficulties and others by providing site where an author may upload creative works for sale at a price set by the author. The website allows users to purchase and rate the works, creating an environment where high-quality works may be identified by users. The website further systematizes the process by which works are acquired by an investment pool, which may be an investment pool run by the website operator. The investment pool will offer to buy the rights of any work achieving a given amount of sales or positive feedback on the site.

### BACKGROUND OF THE INVENTION

The growth of electronic commerce has resulted in many venues in which consumers may purchase creative works, such as music, videos, ringtones, software, games, audio books and writing, online. These online markets for works may have the advantage of more directly connecting authors to buyers than before, through such routes as author blogs, and websites allowing purchasers to display written comments on an author's work. However, many of these online markets suffer in that the feedback is not structured—anyone may comment any number of times about any works. Further, these markets may not provide an appropriate venue for authors who have yet to amass the frame or contacts required to be featured on a large commercial marketplace. In addition, these venues may not allow individuals to exercise the trust relationships they develop, to benefit themselves and others.

### SUMMARY OF INVENTION

In one aspect, the present invention relates to a web site which addresses the above difficulties and others by providing site where an author may upload creative works for sale at a price set by the author. The website allows users to purchase and rate the works, creating an environment where high-quality works may be identified by users. The website further systematizes the process by which works are acquired by an investment pool, which may be an investment pool run by the website operator. The investment pool may offer to buy the rights of any work achieving a given amount of sales or positive feedback on the site.

In one embodiment, the website may comprise: an electronic commerce site which offers for sale a plurality of creative works, each of the creative works having an owner and an assigned price; a community feedback site, linked to the electronic commerce site, which provides inputs for community members to assign points to each of the plurality of creative works; a processor, in communication with the electronic commerce site and community feedback site which calculates, for each of the plurality of creative works, a score based on a number of points assigned to each creative work and a number of times that each creative work has been sold. The site may then suggest and/or implement adjustments to the assigned price of each of the plurality of works in response to the calculated score. Initial prices can be generally be set by the creator/owner of the work.

In another aspect, the present invention relates to a method for using community feedback to promote and discover valuable creative content and the actual creators of such content. In one embodiment, the method comprises: offering for sale via a website, a plurality of creative works, each of the creative works having an owner and an assigned price; allocating, to each of a plurality of owners of creative works offered via the website, a number of points; allocating, to each of a plurality of members of the website, a number of points; providing, via the website to each of the plurality of owners and the plurality of members, inputs which allow assigning of allocated points to a creative work of the plurality of creative works; calculating, for each of the plurality of creative works, a score based on a number of points assigned to each creative work and a number of times that each creative work has been sold; and offering, in response to a determination that a score for a creative work is above a predetermined threshold, to purchase the rights to the creative work from the owner.

### BRIEF DESCRIPTION OF THE DRAWINGS

The foregoing and other objects, aspects, features, and advantages of the invention will become more apparent and may be better understood by referring to the following description taken in conjunction with the accompanying drawings, in which:

FIG. 1 is a block diagram of one embodiment of a system for using community feedback to promote and discover valuable creative content;

FIGS. 2A and 2B depict block diagrams of a typical computer 200 useful as client computing devices and server computing devices;

FIG. 3A is a block diagram of one embodiment of a web page allowing a user to purchase and/or rate creative works;

FIG. 3B is an example screenshot of one embodiment of a web page allowing a user to purchase and/or rate creative works;

FIG. 4A is a block diagram of one embodiment of a web page allowing a user to upload creative works to a web site;

FIG. 4B is an example screenshot of one embodiment of a web page allowing a user to upload creative works to a web site;

FIG. 5A is a block diagram of one embodiment of a web page allowing an author to view details of their currently posted works;

FIG. 5B is an example screenshot of one embodiment of a web page allowing an author to view details of their currently posted works;

FIG. 6 is a block diagram of one embodiment of a web page allowing a reseller to offer for sale creative works;

FIG. 7 is a flow diagram illustrating one embodiment of a method for using community feedback to promote and discover valuable creative content; and

FIG. 8 is an example screenshot of one embodiment of a web page displaying statistics related to a number of works.

### DETAILED DESCRIPTION OF THE INVENTION

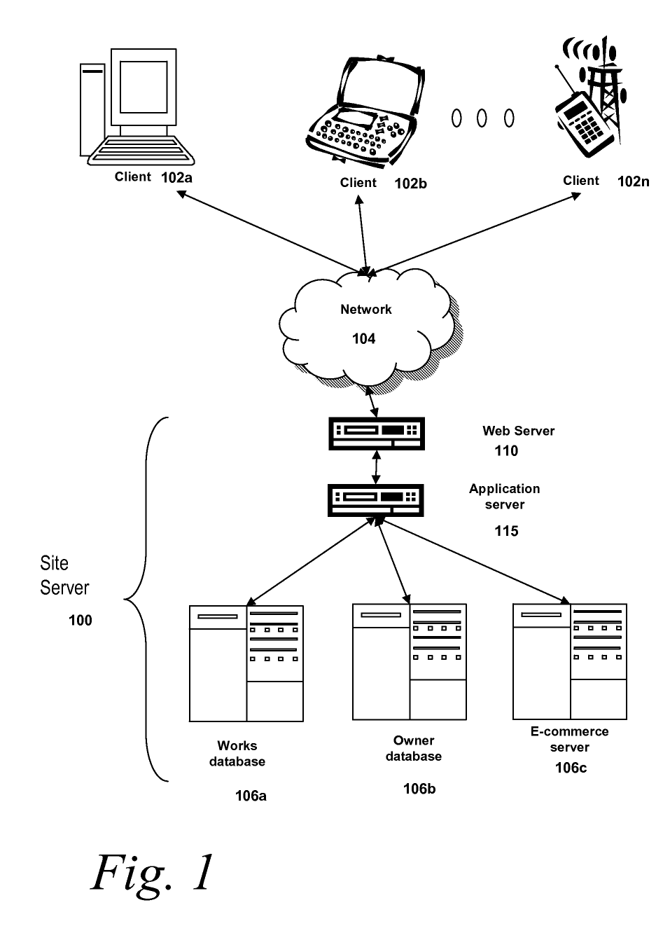

Referring now to FIG. 1, a block diagram of one embodiment of a system for using community feedback to promote and discover valuable creative content is shown. In brief overview, a number of clients, 102a, 102b, . . . 102n (generally 102), are connected via a network 104 to a site server 100. The site server 100 may comprise a number of elements including a web server 110, an application server 115, and a number of databases including an works database 106a, a owner database 106b, and a e-commerce server 106c.

In some embodiments, some or all of the site server 100 elements may occupy the same physical machine, and may share any resources, including processors, memory, and communication links. In other embodiments, a site server element may be distributed across multiple scalable, fault-tolerant, redundant machines. In some embodiments, these machines may be geographically distributed across a number of sites.

Still referring to FIG. 1, now in greater detail, a number of clients 102 are shown. A client may comprise any computing device capable of sending or receiving information. Examples of clients 102 may include personal computers, laptop computers, desktop computers, personal digital assistants, and mobile phones. A client 102 may include a display device, such as a monitor or screen, for displaying a web site to a user, and an input device, such as a keyboard or mouse, for accepting input of data corresponding to the web site.

As shown, the clients 102 are connected to a site server 100 via a network 104. The network 104 may comprise the Internet, local networks, web servers, file servers, routers, load balancers, databases, computers, servers, network appliances, or any other computing devices capable of sending and receiving information. The network 104 may comprise computing devices connected via cables, IR ports, wireless signals, or any other means of connecting multiple computing devices. The network and any devices connected to the networks may communicate via any communication protocol used to communicate among or within computing devices, including without limitation SSL, HTML, XML, RDP, ICA, FTP, HTTP, TCP, IP, UDP, IPX, SPX, NetBIOS, NetBEUI, SMB, SMTP, POP, IMAP, Ethernet, ARCNET, Fiber Distributed Data Interface (FDDI), RS232, IEEE 802.11, IEEE 802.11a, IEE 802.11b, IEEE 802.1g and direct asynchronous connections, or any combination thereof. The network 104 may comprise mobile telephone networks utilizing any protocol or protocols used to communicate among mobile devices, including AMPS, TDMA, CDMA, GSM, GPRS or UMTS. The network may comprise a plurality of physically distinct networks, and the network may comprise a plurality of sub-networks connected in any manner.

A site server 100 may comprise any server or servers capable of sending and receiving data. A site server 100 may perform any function related to the delivery and processing of a web site, including without limitation serving web pages corresponding to browsing and downloading creative works, receiving and processing uploaded works, processing commercial transactions including downloading, uploading, or selling rights to creative works, and contacting and transacting with external resources. In one embodiment, a site server 100 may be implemented using an application server model, wherein a web server 110 handles web requests from clients and serves pages, an application server 115 coordinates page logic, and a number of databases 106 manage data, including without limitation works data, owner data, and electronic commerce data.

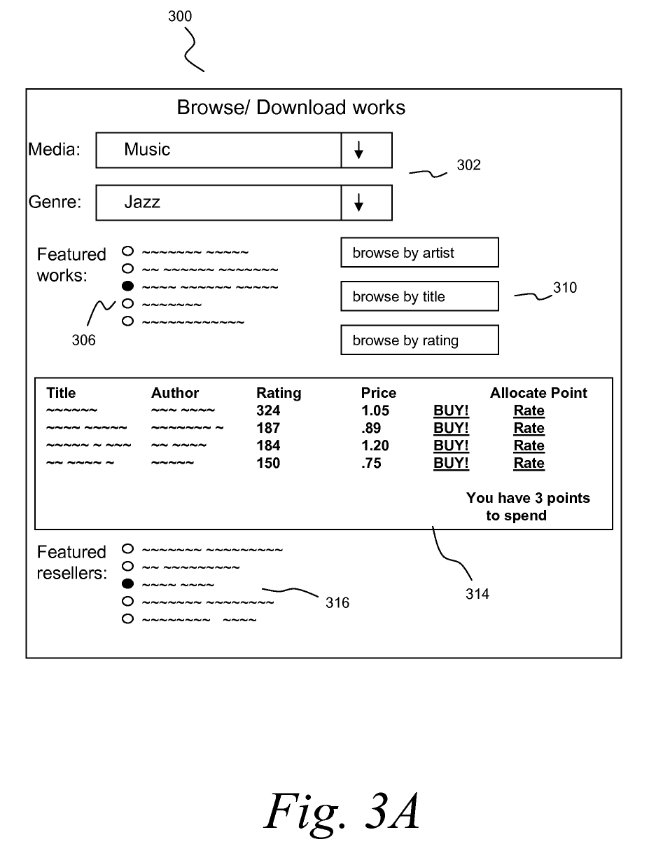

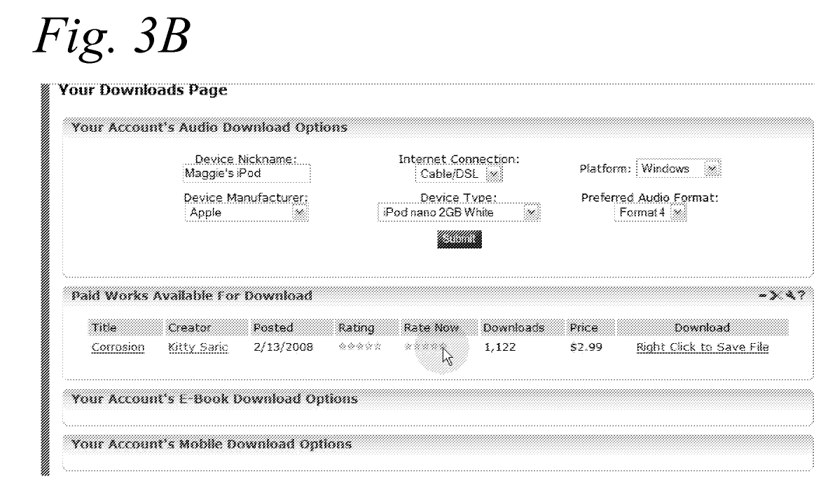

Referring ahead to FIGS. 3, 4, 5, and 6, each of which depict a web page relating to using community feedback to promote, discover, and invest in valuable creative content, a site server may be responsible for the processing and transmission of any of the pages described to a client.

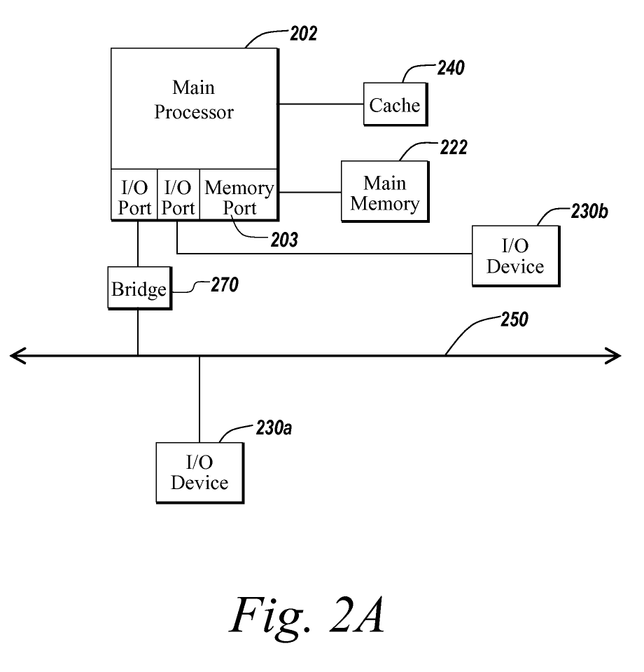

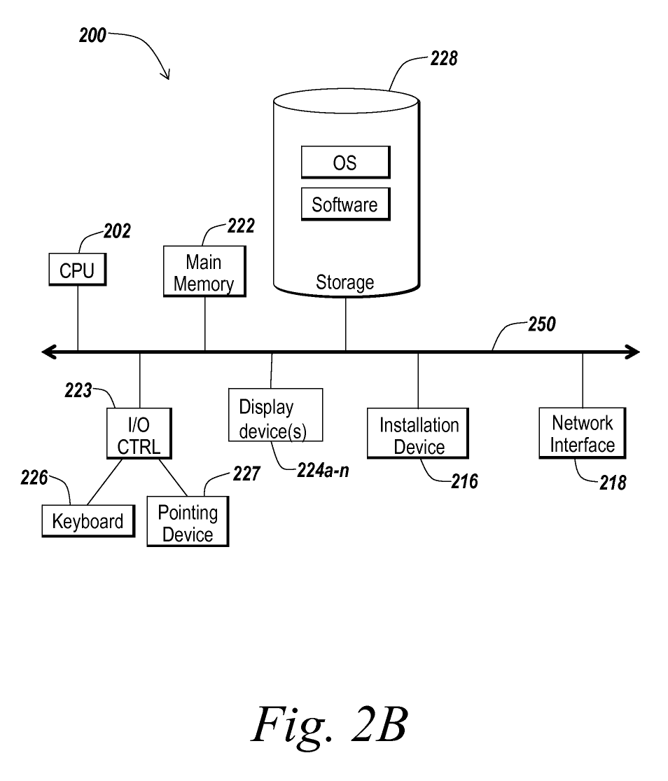

FIGS. 2A and 2B depict block diagrams of a typical computer 200 useful as client computing devices and server computing devices. As shown in FIGS. 2A and 2B, each computer 200 includes a central processing unit 202, and a main memory unit 204. Each computer 200 may also include other optional elements, such as one or more input/output devices 230a-230b (generally referred to using reference numeral 230), and a cache memory 240 in communication with the central processing unit 202.

The central processing unit 202 is any logic circuitry that responds to and processes instructions fetched from the main memory unit 204. In many embodiments, the central processing unit is provided by a microprocessor unit, such as those manufactured by Intel Corporation of Mountain View, Calif.; those manufactured by Motorola Corporation of Schaumburg, Ill.; the Crusoe and Efficeon lines of processors manufactured by Transmeta Corporation of Santa Clara, Calif.; the lines of processors manufactured by International Business Machines of White Plains, N.Y.; or the lines of processors manufactured by Advanced Micro Devices of Sunnyvale, Calif.

Main memory unit 222 may be one or more memory chips capable of storing data and allowing any storage location to be directly accessed by the microprocessor 202, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC 100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM). In the embodiment shown in FIG. 2A, the processor 202 communicates with main memory 222 via a system bus 250 (described in more detail below). FIG. 2B depicts an embodiment of a computer system 200 in which the processor communicates directly with main memory 204 via a memory port. For example, in FIG. 2B the main memory 204 may be DRDRAM.

FIGS. 2A and 2B depict embodiments in which the main processor 202 communicates directly with cache memory 240 via a secondary bus, sometimes referred to as a “backside” bus. In other embodiments, the main processor 202 communicates with cache memory 240 using the system bus 250. Cache memory 240 typically has a faster response time than main memory 222 and is typically provided by SRAM, BSRAM, or EDRAM.

In the embodiment shown in FIG. 2A, the processor 202 communicates with various I/O devices 230 via a local system bus 250. Various busses may be used to connect the central processing unit 202 to the I/O devices 230, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is an video display, the processor 202 may use an Advanced Graphics Port (AGP) to communicate with the display. FIG. 2A depicts an embodiment of a computer system 200 in which the main processor 202 communicates directly with I/O device 230b via HyperTransport, Rapid I/O, or InfiniBand. FIG. 2A also depicts an embodiment in which local busses and direct communication are mixed: the processor 202 communicates with I/O device 230a using a local interconnect bus while communicating with I/O device 230b directly.

A wide variety of I/O devices 230 may be present in the computer system 200. Input devices include keyboards, mice, trackpads, trackballs, cameras, video cameras, microphones, and drawing tablets. Output devices include video displays, speakers, inkjet printers, laser printers, and dye-sublimation printers. An I/O device may also provide mass storage for the computer system 200 such as a hard disk drive, a floppy disk drive for receiving floppy disks such as 3.5-inch, 5.25-inch disks or ZIP disks, a CD-ROM drive, a CD-R/RW drive, a DVD-ROM drive, tape drives of various formats, and USB storage devices such as the USB Flash Drive line of devices manufactured by Twintech Industry, Inc. of Los Alamitos, Calif.

In further embodiments, an I/O device 230 may be a bridge between the system bus 250 and an external communication bus, such as a USB bus, an Apple Desktop Bus, an RS-132 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

General-purpose computers of the sort depicted in FIG. 2A and FIG. 2B typically operate under the control of operating systems, which control scheduling of tasks and access to system resources. Typical operating systems include: MICROSOFT WINDOWS, manufactured by Microsoft Corp. of Redmond, Wash.; MacOS, manufactured by Apple Computer of Cupertino, Calif.; OS/2, manufactured by International Business Machines of Armonk, N.Y.; and Linux, a freely-available operating system distributed by Caldera Corp. of Salt Lake City, Utah, among others.

For embodiments comprising mobile devices, the device may be a JAVA-enabled cellular telephone, such as the i55sr, i58sr, i85s, or the i88s, all of which are manufactured by Motorola Corp. of Schaumburg, Ill.; the 6035 or the 7135, manufactured by Kyocera of Kyoto, Japan; or the i300 or i330, manufactured by Samsung Electronics Co., Ltd., of Seoul, Korea. In other embodiments comprising mobile devices, a mobile device may be a personal digital assistant (PDA) operating under control of the PalmOS operating system, such as the Tungsten W, the VII, the VIIx, the i705, all of which are manufactured by palmOne, Inc. of Milpitas, California. In further embodiments, the client 113 may be a personal digital assistant (PDA) operating under control of the PocketPC operating system, such as the iPAQ 4155, iPAQ 5555, iPAQ 1945, iPAQ 2215, and iPAQ 4255, all of which manufactured by Hewlett-Packard Corporation of Palo Alto, Calif.; the ViewSonic V36, manufactured by ViewSonic of Walnut, California; or the Toshiba PocketPC e405, manufactured by Toshiba America, Inc. of New York, N.Y. In still other embodiments, the mobile device is a combination PDA/telephone device such as the Treo 180, Treo 270, Treo 600, Treo 650, Treo 700, or the Treo 700w, all of which are manufactured by palmOne, Inc. of Milpitas, Calif. In still further embodiments, the mobile device is a cellular telephone that operates under control of the PocketPC operating system, such as the MPx200, manufactured by Motorola Corp. A typical mobile device may comprise many of the elements described above in FIGS. 2A and 2B, including the processor 202 and the main memory 204.

Referring now to FIGS. 3, 4, 5, and 6, block diagrams depicting example web pages which together may form a web site for using community feedback to promote, discover, and invest in valuable creative content and creators are shown. Although each of the pages are shown separately, the pages may be linked or combined in any manner. For example, any of the web pages shown may comprise a link or navigation bar allowing a viewer to navigate to any of the other pages shown. In some embodiments, each of the pages shown may reflect creative works pulled from a common database. In other embodiments, each of the pages may share any other data in common. In some embodiments, some or all of the pages may be provided by a site server 100.

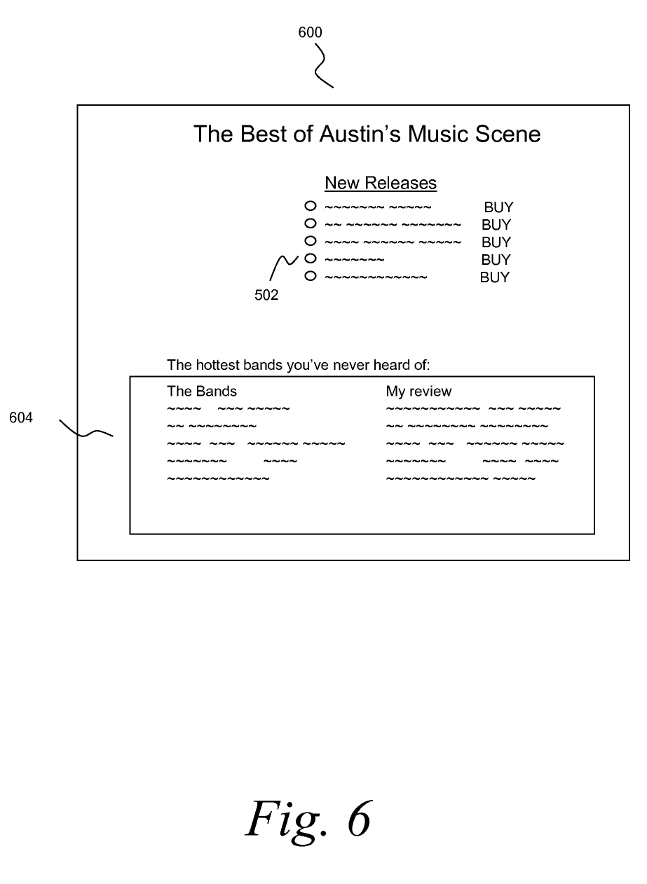

In one embodiment, the web pages shown in FIGS. 3, 4, 5, and 6 may be used to enable a web site and/or online community for facilitating the buying, investing, and publicizing of creative works. The web site may serve as a forum in which an author (who may be, for example, an author, writer, musician, programmer or inventor), may post their creative work, (which may be, for example, a song, video, book, article, poem, photo, painting, idea, program, or invention) at no cost to the author. As part of the posting, the author will fill out an electronic form (for example, the form shown in FIG. 6) that may document, for example, the date the work was posted, who created the work, who the claimed owners of the work are, and any additional information related to the work. The site operator may then document the receipt of the work and store this information.

As used herein the term “creative work” may comprise any work involving expression by one or more authors, including without limitation music recordings such as songs & albums; literature such as stories, novels, books, poetry and plays; art such as images, photographs, comics, and sketches; cinema such as movies, short films, documentaries, and animations; and software such as productivity software, web applications, plug-ins, libraries, and games for computing devices including without limitation workstations, desktops, laptops, personal digital assistants, and mobile phones.

The web site may then make the work available for sale in a non-exclusive manner on the for a price that may be set and modified by the author, for a period of time determined by the site operator. The web site may provide real-time tools to help the author price their works, such as comparative pricing based on the author and work profile and that of other authors and works on the site. In some embodiments, authors may be allowed to adjust the price charged for their work at any time. In other embodiments, an author may be required to set a given price or minimum price which lasts for at least a period of time.

In some embodiments, authors may keep 100% of all proceeds from the sale of the work for a predetermined amount of time, less a fixed administrative fee for each sale transaction. In other embodiments, the site operator may recoup an initial administrative fee for each song posted, in order to cover storage and bandwidth. For example, the site operator may keep the first $10 in sales from the work to cover initial costs. In some embodiments, an author may pay an initial fee or agree to yield a higher percentage of proceeds from sales in exchange for additional promotion on the web site. Such additional promotion may include without limitation banner advertisements, advantageous placement in search results, and featured reviews.

The author may also receive, in conjunction with posting a work, a page on the web site were they may post personal information, tour schedules, etc.; and where buyers on the web site may go to post comments to the author or be listed as a fan. Fans with their own page on the web site may also link to an author's page from their own page. The author may then have the ability to send mass emails and/or text messages to fans when they post a new work.

A web site may then make the uploaded works available to purchasers in any manner. In some embodiments, the web site may allow users to preview a work (e.g. receive a portion of an audio stream). If the product is desirable to a buyer, the buyer may purchase and download it for the price set by the author using any means of electronic transaction.

In some embodiments, a buyer may be provided with facilities to create an account which will allow them to easily purchase works, build a personalized web page, and participate in rating works. The web site may also allow buyers with accounts to contact and be contacted by authors. In some embodiments, a buyer may be incentivized to create an account by an offer of one or more free downloads. A buyer may also be incentivized to participate in rating works by offering one or more free downloads in response to a buyer rating a given number of works.

A web site may also provide functionality for one or more resellers to also operate web pages selling the works. A reseller may be an author, investor, buyer, fan or any other entity with an interest in reselling one or more works. In some embodiments, a site server 100 may provide functionality for one or more resellers to create web pages selling works that are then hosted by the site server 100. The site server may provide any functionality associated with the reseller page, including e-commerce support and access to databases of information relating to the works. In other embodiments, some or all of the elements of a reseller site may be hosted by devices other than the site server 100.

In one embodiment, a reseller may pay a one-time fee to host their own page on the web site that gives the reseller the ability to post any works of their choosing in a manner so that a buyer has the ability to buy the works directly from the reseller's page. In some embodiments, the web site will only make available works for reselling if they have been designated as resellable by the author. In other embodiments, authors may be required to pay a fee if they would like a work to be able to be included on reseller pages. In the event that a buyer purchases an author's work from a reseller's page, the reseller may be paid a commission for the sale.

In some embodiments, an author may be required to pay a fee if they would like their works to be available to be resold by resellers. For example, an author may have a to pay a small fee to have a given work made eligible for resellers to sell. Or for example, an author may be required to purchase a subscription or membership to have all their works eligible for resale by resellers for a given period of time.

In some embodiments, a web site may provide a rating system through which users of the web site can rate the works made available through the site. In one embodiment, each user of the web site (for example a buyer with an account or an author with one or more posted works) may receive a number of rating points which they can allocate to works of their choice. The works may then be assigned a rating based on the number of points they attract. For example, each account holding buyer and investor may be given 2 points per day that they may distribute to any work(s) of their choosing. Each author may be given a number of points per day per work based on how many works they have on the web site. The author and/or account holder may lose the points if they do not distribute them each day, which may encourage frequent visits to the site. Works may also gain points based on being sold or previewed.

In some embodiments, the rating may be adjusted to reflect how many points were allocated to a work recently. For example, each work might automatically loose 2 points per day, thereby helping to designate the hot products from the products not receiving recent attention. In some embodiments, users of the web site may set alerts to receive notifications when certain rating or sales triggers are hit. For example, a user may wish to be notified any time a work receives more than 1000 points. Or for example, an author may wish to be notified if one of their works surpasses 2000 sales.

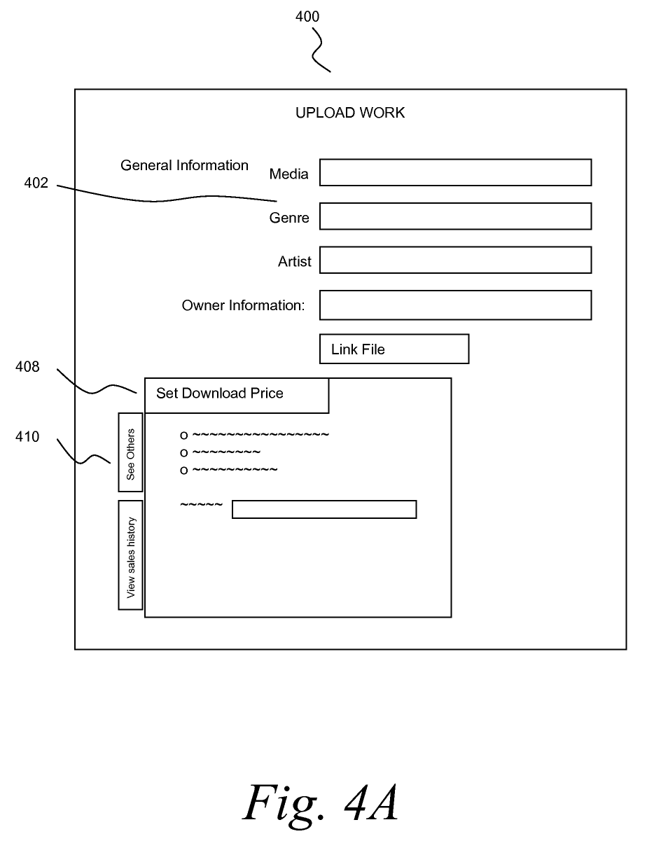

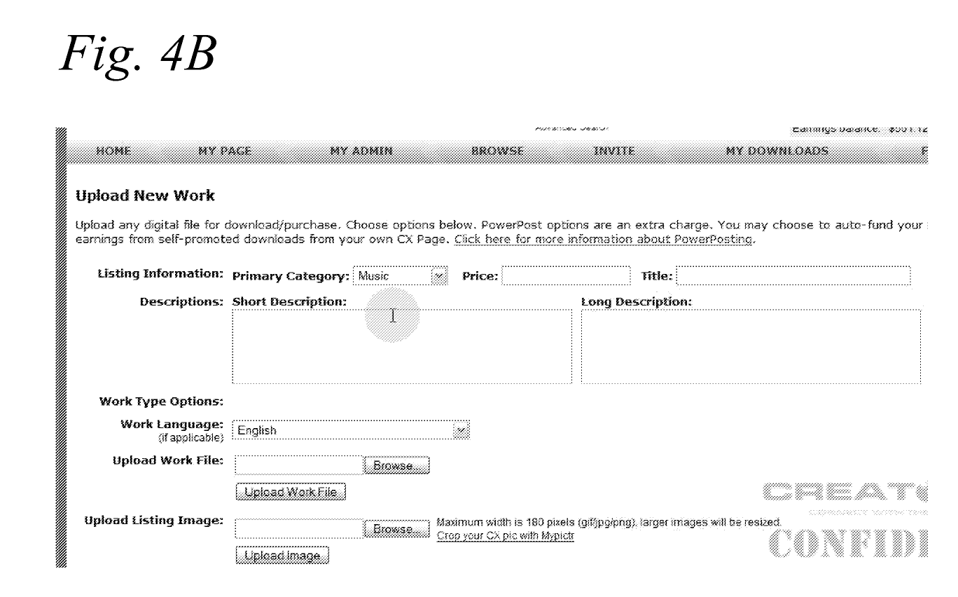

In some embodiments, the web site may offer investors a chance to buy rights to works posted on the site (for example using the screen depicted in FIG. 4) In some embodiments, a work may only become eligible to be purchased after it achieves a given threshold of ratings or purchases. The author may then offer the work to an investor group that has invested in a pool of funds, managed by the site operator, to be used for buying the rights to works and then promoting those works. The price of the work paid by the investors may be proportional to the success of the work and/or author, prior to being bought by the investor group. For example, the investors may pay a premium on the amount a work had already made, in order to get the full rights to the work. For example if a song had grossed $100, the investor pool might pay 3× that amount to the author, at which point, the song would be owned by the investor pool. In some cases, the multiplier for the purchase price (i.e. the 3× in this case) may be variable and may change regularly based on the investor pool's determinations of current market dynamics and available capital. The multiplier may be posted in one or more areas of the web site or may just be used internally to the site to calculate a purchase price that is offered to the creator of the work.

After the work is purchased by the investor pool, it may be internally noted that ownership has changed, but the work may still be offered for sale in the same manner as before. At this point the investor pool may take additional efforts to promote the work, such as by posting the work on other commercial sites and/or making the work available for licensing. A work may also be promoted on genre specific streaming media shows. As part of the purchase transaction for the work, the investment pool may agree to certain promotion activity at predetermined revenue (or rating point) levels, supported by a fund set aside for promotions. The better a song does in the pool (e.g. the more revenue it produces), the more a promotional fund may be allocated to promote the song.

After a work is purchased by an investor pool, revenues from future sales via the web site may be allocated in any manner. For example, ¼ of revenue may go to the investor pool, ¼ may go to promotional efforts, ¼ may go to the author, and ¼ may go to the site operator. In some embodiments, this sharing split may be variable and applied on a per work basis.

Still referring to FIGS. 3, 4, 5, and 6, the example web pages shown may be displayed on any display device of any of the computing devices 100 described herein. In some embodiments, a web page may be displayed on a computer monitor inside a browser. A web page may comprise any display, scripting, or programming language including HTML, XML, SVG, Java, Javascript, and Flash. The web pages depicted may comprise a number of fields. Said fields may comprise any means for accepting input, including text boxes, text fields, password fields, check boxes, radio buttons, buttons, dials, toggles, sliders, scroll bars, lists, links, and menus. Any and all of said fields may comprise functionality for auto-completion. Any and all of said fields may comprise default values and presets. In some embodiments, the web pages may utilize a scripting language, such as Javascript, to provide functionality associated with filling in, storing, or displaying data.

Referring now to FIG. 3, a block diagram of one embodiment of a web page allowing a user to purchase and/or rate creative works is shown. In brief overview, the web page 300 comprises one or more menus 302 or browsing features 310 to view a number of works. The web page may also prominently feature one or more works in a designated position 306. When viewing the works, a user may be provided with an interface 314 allowing the user to see details of the work, purchase the work, or allocate rating points to the work. The web page 300 may also contain one or more links 316 to other pages, such as reseller pages.

Still referring to FIG. 3, now in greater detail, a web page 300 may contain any functionality allowing a user to browse, search, or otherwise locate and view works, including without limitation menus 302, search dialogs 310, and featured selections 306. The web page 300 may also comprise any functionality allowing a user to purchase works. Such functionality may include any purchase systems or methods used in electronic commerce systems, including without limitation credit/debit card payments, bank transfers, online account transfers and gift card purchases. After purchasing a work, the work may be transferred to the user in any manner, including without limitation by downloading or streaming.

The web page 300 may also comprise any functionality for allowing a user to allocate rating points to a work. A web page may include any input, including without limitation buttons, links, checkboxes, and text boxes to allow a user to allocate rating points to a work. The web page may also contain an indication of the number of rating points the user currently has to be allocated.

Referring now to FIG. 3B, an example screenshot of one embodiment of a web page allowing a user to purchase and/or rate creative works is shown. The screen shown presents a user with a list of songs which are available for the user to download. The user may also rate the work and view a rating assigned to the work.

Referring now to FIG. 4, a block diagram of one embodiment of a web page allowing a user to upload creative works to a web site is shown. The upload page 400 may comprise inputs 402 for specifying general information about a work, and for linking a file which may comprise the work or a link to the work. The upload page 400 may also comprise inputs 408 for an author to set the price which will be charged for a user to download the work. The upload page may provide related price information 410 of other works to assist in setting the price. FIG. 4B is an example screenshot of one embodiment of a web page allowing a user to upload creative works to a web site

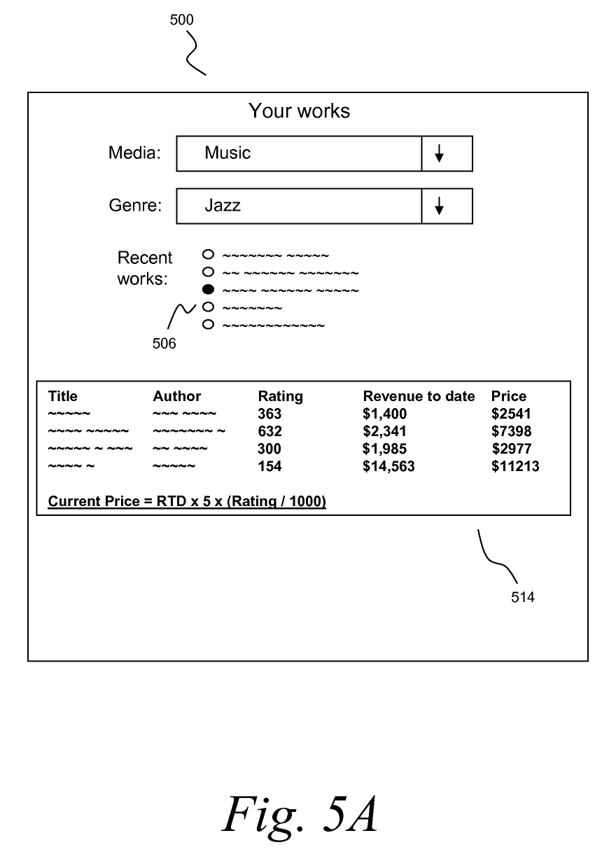

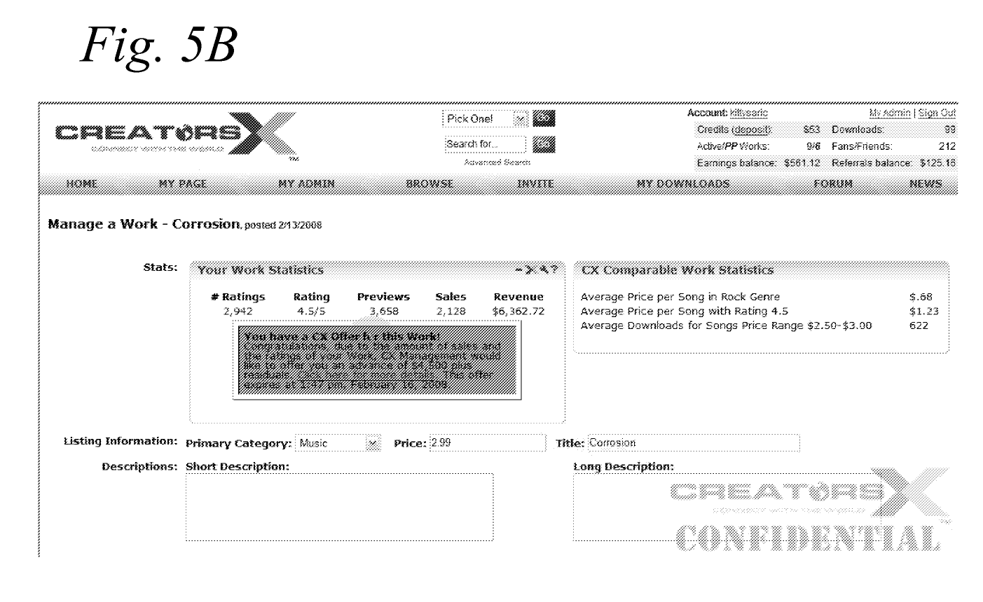

Referring now to FIG. 5A, a block diagram of one embodiment of a web page allowing an author to view details of their currently posted works is shown. The page 500 may comprise a listing of the currently posted works along with any related information. Such information may include, for example, net sales revenue, current rating, a current price offered to purchase rights to the work, and a current formula for determining offering price. In some embodiments, the author may be able to perform management functions from the web page 500, including without limitation setting the download price for works, or accepting or declining an offer to purchase the rights to a work.

FIG. 5B shows an example screenshot of one embodiment of a web page allowing an author to view details of their currently posted works. The screenshot shows a page displaying a work's rating, sales, and any outstanding offers to purchase the work. the page also displays user account information, such as an account balance, “fans,” total number of downloads, and earnings.

Referring now to FIG. 6, a block diagram of one embodiment of a web page allowing a reseller to offer for sale creative works is shown. The reseller page 600 may comprise any web page created by a reseller which offers works from the web site for sale. A reseller may create a reseller page in any manner, including without limitation from predetermined templates or from scratch. A reseller page may include any content desired by the reseller, and may include content in addition to the works offered for sale.

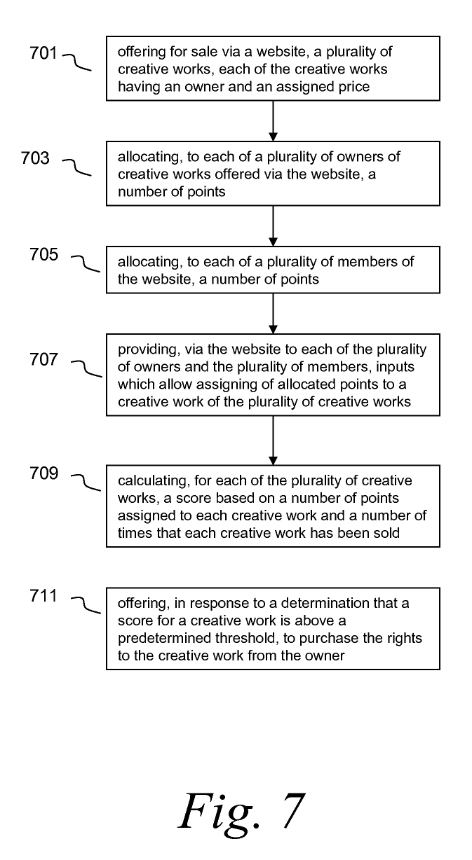

Referring now to FIG. 7, a flow diagram illustrating one embodiment of a method for using community feedback to promote and discover valuable creative content is shown. In brief overview, the method comprises: offering for sale via a website, a plurality of creative works, each of the creative works having an owner and an assigned price (step 701). A plurality of owners of creative works and members of the website are then allocated a number of points (steps 703 and 705). The web site may then provide, to each of the plurality of owners and the plurality of members, inputs which allow assigning of allocated points to a creative work of the plurality of creative works (step 707). For each of the plurality of creative works, a score may be calculated based on a number of points assigned to each creative work and a number of times that each creative work has been sold (step 709). In response to a determination that a score for a creative work is above a predetermined threshold, an offer may be made to purchase the rights to the creative work from the owner (step 711).

Still referring to FIG. 7, now in greater detail, a plurality of creative works may be offered for sale via a website in any manner. In some embodiments, the works may be offered via a web page 300 or a reseller page 600. In some embodiments, the price charged for a works may be set by an author of the work. In other embodiments, the price of the works may be set by a site operator or a third party.

A plurality of owners of creative works and members of the website may be allocated a number of points in any manner (steps 703 and 705). In some embodiments, owners may be allocated points based on the number of works the owners make available to the website. In other embodiments, owners may be allocated points based on the ratings received by works the owners have posted. In still other embodiments, owners may be allocated points based on a number of sales the owners' works have made. In some embodiments, points may be allocated to site members based on how many works the site members have purchased. In other embodiment, points may be allocated to site members based on a level of site activity, which may include, for example, a number of page views or songs previewed.

The web site may then provide, to each of the plurality of owners and the plurality of members, inputs which allow assigning of allocated points to a creative work of the plurality of creative works (step 707). In some embodiments, the inputs may be provided via a web page 300. In other embodiments, an owner or member of a website may be prompted to assign points to a work after purchasing, previewing, or uploading the work.

For each of the plurality of creative works, a score may be calculated in any manner based on a number of points assigned to each creative work and a number of times that each creative work has been sold (step 709). In some embodiments, the score may comprise the total points allocated to a work added to the number of times the work has been sold. In other embodiments, a formula for calculating the score may be expressed in the form:

a(points)+b(sales)+c(previews)

where “points” is a current number of points for a work, sales is a current number or total value of sales of a work, and previews is the number of times a work has been previewed, and a, b, and c are all constants which may be assigned any weight. In some embodiments, point allocations, sales, and previews may all be monitored for potential fraud. In other embodiments, the above formula may be modified so that the contribution of points or previews to a work's score is capped at a given amount. In other embodiments, additional factors may be added to the above formula.

In response to a determination that a score for a creative work is above a predetermined threshold, an offer may be made to purchase the rights to the creative work from the owner (step 711). For example, the site may have a policy that a work scoring over 2000 (which may represent, for example, at least 2000 ratings points assigned or 2000 sales) will be eligible to have its rights bought by an investment pool managed by the site operator. The threshold may be computed in any manner, and may vary over time.

In some embodiments, a site storing a number of music works may offer a service allowing users to create, store on the site, and stream custom playlists from the works contained in the site's musical works database. The user may choose individual works to be included in the database or allow the site to create custom streams for the user. these custom streams may be created in any manner, including without limitation based on the user's demographics, the user's purchase history, the user's streaming history, and data from a peer group of users or data from all other users. A user may store different stream profiles for various “moods” or genres of musical works. In some embodiments, a playlist may have a set price, such as 10 songs for $3/month. In other embodiments, a playlist may have credits attached to it which relate in some way to the price a song would cost if it was purchased in this manner.

In some embodiments, the above streaming playlist service may be offered for a daily, weekly or monthly. In some embodiments, the site may track all works streamed to the user and give the user the ability to purchase any work streamed by clicking a link. In some embodiments, the site may offer works recently streamed to a user at a discount provided that the user purchases the works within a certain amount of time. In still other embodiments, the user may purchase an entire stream for a discounted price.

In further embodiments, outside investors and potential licensees or promoters will be given access to select site activity data, at the discretion of individual creators, in order to help link up creators with those who can assist them in leveraging the creator's works. For example, an outside investor may be given access to day-by-day sales data of one or more authors in exchange for a fee. In a further embodiment, an author may pay to be given access to select site activity related to investors or promoters viewing their statistics, in order to better inform the creators of the activity related to their works. For example, an author may be given access to sales data of songs before and after they were promoted by a promoter in exchange for a fee. Either of these monitoring services could be offered by the site as a for fee service, either by charging on a per-work, per-author, per-promoter, or time subscription basis.

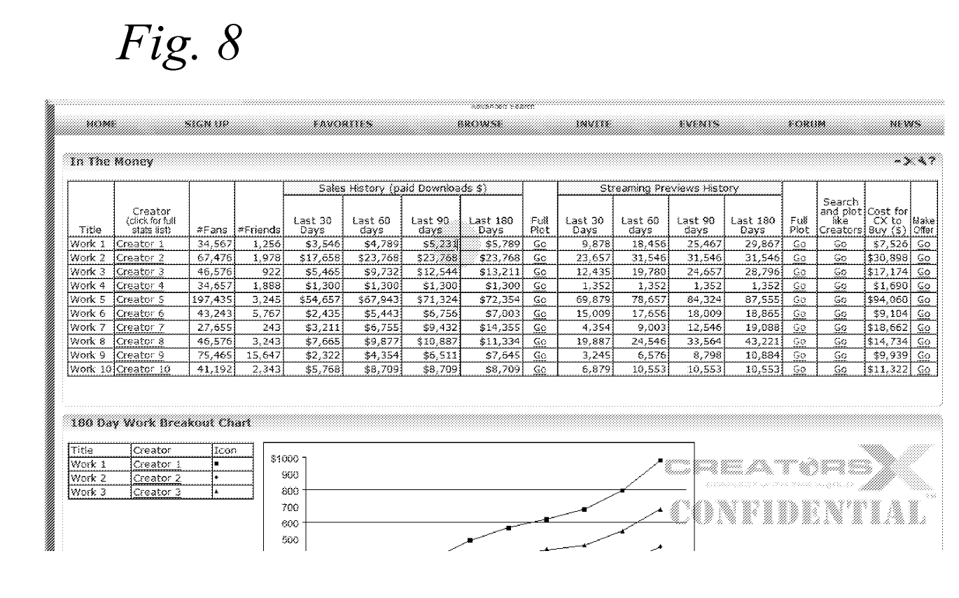

FIG. 8 shows an example screenshot of one embodiment of a web page displaying statistics related to a number of works. A number of works may be displayed, along with statistics showing sales over various time periods, number of previews, and ratings. Any of the statistics may be illustrated with one or more graphs.

While the invention has been particularly shown and described with reference to specific preferred embodiments, it should be understood by those skilled in the art that various changes in form and detail may be made therein without departing from the spirit and scope of the invention as defined by the appended claims.

We claim:

1. A method for using community feedback to promote and discover valuable creative content and creators, the method comprising:
a. offering for sale, via a website, a plurality of creative works, each of the creative works having an owner and an assigned price;
b. allocating, to each of a plurality of owners of creative works offered via the website, a number of points;
c. allocating, to each of a plurality of members of the website, a number of points;
d. providing, via the website to each of the plurality of owners and the plurality of members, inputs which allow assigning of allocated points to a creative work of the plurality of creative works;
e. calculating, for each of the plurality of creative works, a score based on a number of points assigned to each creative work and a number of times that each creative work has been sold; and
f. offering, in response to a determination that a score for a creative work is above a predetermined threshold, to purchase the rights to the creative work from the owner.

2. The method of claim 1, wherein step (b) comprises allocating, to each of a plurality of owners of creative works offered via the website, a number of points based on a number of creative works offered by each owner.

3. The method of claim 1, wherein step (b) comprises allocating, to an entity selected from the group of: an author, reseller, customer, publisher, and investor, a number of points based on a metric of the entity's participation in the website.

4. The method of claim 1, wherein step (b) comprises allocating, for a number of predetermined time periods to each of a plurality of owners of creative works offered via the website, a number of points, the points expiring at the end of each predetermined time period.

5. The method of claim 1, wherein step (e) comprises calculating, for each of the plurality of creative works, a score based on a number of points assigned to each creative work, a number of times that each creative work has been sold, and a number of times that each creative work has been previewed.

6. The method of claim 1, further comprising the step of displaying a suggested adjusted price for each of the plurality of works in response to the calculated score.

7. A website for using community feedback to promote and discover valuable creative content and creators, the website comprising:
an electronic commerce site which offers for sale a plurality of creative works, each of the creative works having an owner and an assigned price;
a community feedback site, linked to the electronic commerce site, which provides inputs for community members to assign points to each of the plurality of creative works;
a processor, in communication with the electronic commerce site and community feedback site which calculates, for each of the plurality of creative works, a score based on a number of points assigned to each creative work and a number of times that each creative work has been sold, and outputs a suggested adjustment to the price of each of the plurality of works in response to the calculated score.

8. The website of claim 7, wherein the community feedback site allocates, to each of a plurality of owners of creative works offered via the website, a number of points based on the number of creative works offered by each owner.

9. The website of claim 7, wherein the community feedback site allocates, to an entity selected from the group of: an author, reseller, customer, publisher, and investor, a number of points based on a metric of the entity's participation in the website.

10. The website of claim 7, wherein the community feedback site allocates, for each of a number of predetermined time periods to each of a plurality of owners of creative works offered via the website, a number of points, the points expiring at the end of each predetermined time period.

11. The website of claim 7, wherein the processor calculates, for each of the plurality of creative works, a score based on a number of points assigned to each creative work, a number of times that each creative work has been sold, and a number of times that each creative work has been previewed.

12. The website of claim 7, further comprising at least one reseller page, the reseller page comprising a page operated by a community member and offering for sale a subset of the creative plurality of creative works, wherein the community member is paid a commission for each sale via the reseller page.

13. The website of claim 7, further comprising at least one reseller page, the reseller page comprising a page operated by a community member and offering for sale a subset of the creative plurality of creative works, wherein the a third party specified by the community member is paid a commission for each sale via the reseller page.

14. The website of claim 7, wherein the electronic commerce site displays a suggested adjusted price for each of the plurality of works in response to the calculated score.

15. The website of claim 7, wherein the electronic commerce site accepts payment of a fee from an author, and, in response to the fee, makes at least one work created by the author eligible for sale by at least one reseller.

16. The website of claim 7, wherein the electronic commerce site displays statistics for a work based on at least one of: a calculated score of the work, sales of the work, and the author of the work.

17. The website of claim 7, wherein the electronic commerce site displays, for a fee, statistics for a work based on at least one of: a calculated score of the work, sales of the work, and the author of the work.
